(19) United States
(12) Patent Application Publication
(10) Pub. No.: US 2008/0256746 A1
(43) Pub. Date: Oct. 23, 2008

(54) FITTING FOR THE PIVOTING SUPPORT OF A SHUTTER

(76) Inventor: Wei Xue Yuan, Dongguan City (CN)

Correspondence Address: SINORICA, LLC, 528 FALLSGROVE DRIVE, ROCKVILLE, MD, 20850, US

(21) Appl. No.: 11/736,584

(22) Filed: Apr. 18, 2007

(51) Int. Cl. E05D 3/00

(52) U.S. Cl. 16/223

(57) ABSTRACT

A fitting for a shutter sash includes a bearing body, a support plate and a reinforcing rib. The bearing body consists of a stationary plate, a movable plate pivotally connected to one another. The stationary plate is fixed onto a window frame or the like, and the movable plate is fixed on a shutter sash so that the oscillating-swing shutter may pivotally rotate by means of the fitting. The support plate extends traversely from lower portion of the movable plate in a predetermined length. The reinforcing rib made integrally with and extending traversely from predetermined portion of the fitting orienting towards the shutter sash to form into a predetermined shape. A rabbet groove formed on the shutter sash in a corresponding position to the reinforcing rib so as to allow the reinforcing rib to be inserted and further improve the mechanical strength of the unit, so the shutter could be securely suspended thereon.

### BACKGROUND OF THE INVENTION

1. Field of the Invention

This invention pertains to a shutter accessory, more particularly to a fitting for pivotally supporting a shutter sash on the frame in such a way that it can tilted around a horizontal axis as desired, enhancing mechanical strength of the shutter structure making it substantially durable and not easy to disengage therefrom.

2. Description of the Prior Art

A traditional shutter is generally composed of a frame consisting of a right side block, a left side block, an upper block and a bottom block, and a plural louvers arranged at interior area of the frame, and then has one side block pivotally connected with fittings that are also pivotally connected with a window frame so that the shutter may be possible to swing to open or close around the window frame.

FIG. 1 shows a conventional fitting 1 for a shutter, composed of a stationary plate 2, a movable plate 3 and a pin 4 pivotally connecting the stationary plate 2 with the movable plate 3 in such a way that the stationary plate 2 can be fixed tightly onto a predetermined position near upper portion and lower portion of one of the side stiles of a window frame, with the movable plate 3 securely fixed with one side block of the shutter, allowing the shutter to pivotally swing to open or close around the window frame. However, the conventional fittings 1 support the shutter vertically, so the level of suspension strength of the fittings acting upon the shutter may gradually weaken because of the frequent tilting operations while swinging shutter to open and close, with the adding weight of the shutter itself the supporting level of the fittings also may gradually lessen, causing the shutter to incline downwardly or disengage therefrom so that the product durability of such shutter may be substantially reduced.

There are some conventional fittings disclosed in four U.S. Pats. in accordance of U.S. Pat. No. 6,772,480 titled “Fitting having support arm or swing arm for supporting a turning sash or a turning-tilting sash”, U.S. Pat. No. 6,421,877 titled “Fitting for the pivoting support of a window sash or door leaf”. U.S. Pat. No. 6,286,262 titled “Fitting having support arm or swing arm for supporting a turning sash or a turning-tilting sash”, and U.S. Pat. No. 5,095,583 titled “Folding-arm bearing for an oscillating-swinging leaf.” These four devices are similar in functioning designs for the fittings of shutters, having varying structures for supporting shutter sashes or the like, enable fittings to pivotally suspend the shutters and improve the level of connection among the shutter components and further prevent the shutter to decline downwardly in times. However, the four U. S. Pats mentioned above have reinforced rigidity of the window sash structures, only that they are all complicated to assemble causing a loss of time and also generating higher manufacturing costs.

### SUMMARY OF THE INVENTION

The feature of a fitting for a shutter in the present invention is a bearing body consisting of a stationary plate and a movable plate pivotally engaged to one another, a support plate and a reinforcing rib. The stationary plate is securely fixed onto a predetermined upper and lower portion of a side stile of a window frame, and the movable plate is fastened on a predetermined upper and a lower portion of a side block of a shutter frame. The support plate made integral to extend from the lower edge of the movable plate into a predetermined length, which is fixed upon the top block and the bottom block of the shutter. The reinforcing rib made integral taking the form of predetermined shape extending sidewisely from the upper and lower edges of the movable plate facing in an orientation towards the shutter and such reinforcing rib also is jointedly connected with the support plate. A rabbet groove formed on one of the shutter surface with respective position to such reinforcing rib, allowing the reinforcing rib to be securely inserted therein.

The fitting for a shutter in the present invention has simplified the structure and much easier to assemble comparatively to those disclosed in the conventional ones and is made integral, with the support plate strengthened by the reinforcing rib to substantially increase the level of supportability to the shutter in such a way that the support plate may not easily become deformed in times, and can further enhance the operations stability of the shutter fixed on a frame in such a way that it can pivot around the horizontal axis in a limited scope. Such fitting is simple in structure and convenient to assemble leading substantially lower in manufacturing costs.

### BRIEF DESCRIPTION OF DRAWINGS

This invention will be better understood by referring to the accompanying drawings, wherein:

FIG. 1 is a perspective view of a conventional fitting for a shutter;

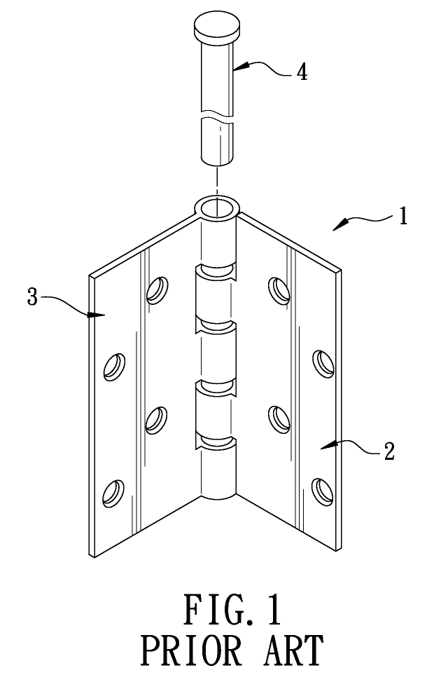

FIG. 2 is a perspective view of a first preferred embodiment of a fitting for a shutter in the present invention;

FIG. 3 is a perspective view of the first preferred embodiment of a fitting for a shutter, showing it combined with a shutter and a window frame;

FIG. 4 is a perspective view of a second preferred embodiment of a fitting for a shutter in the present invention; and,

FIG. 5 is a perspective view of the second preferred embodiment of a fitting for a shutter in the present invention, showing it combined with a shutter and a window frame.

### DETAILED DESCRIPTION OF THE PREFERRED EMBODIMENTS

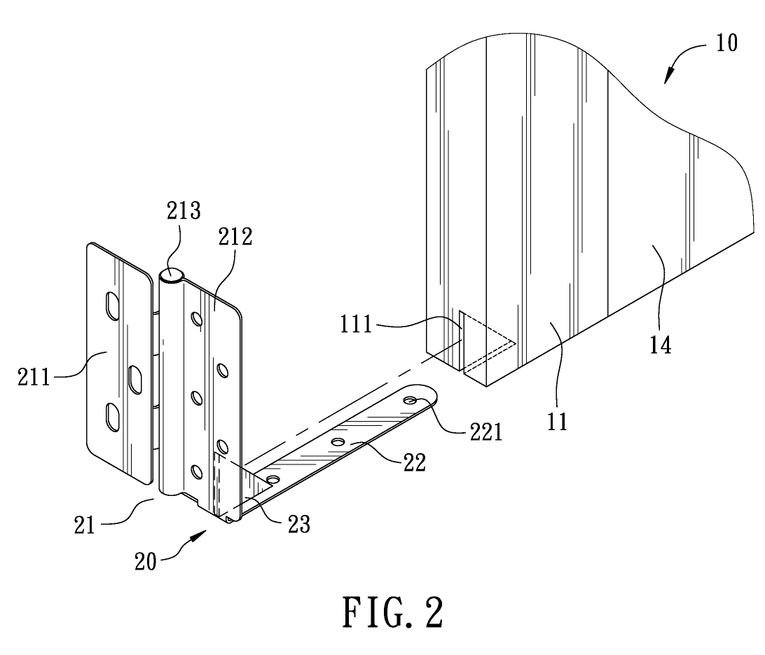

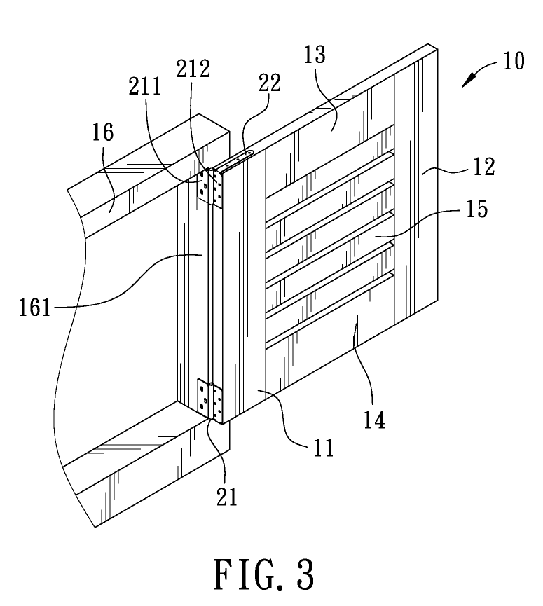

A first preferred embodiment of a fitting 20 for a shutter in the present invention, as shown in FIGS. 2 and 3, includes a bearing body 21, a support plate 22, and a reinforcing rib 23 as main components. A shutter 10 includes a frame consisting of two side bocks 11 and 12, a top block 13. a bottom block 14, and a plurality of horizontal louvers 15 arranged at interior area of the frame, fastened onto a window frame 16 by the means of two respective fittings 20 securely attached at upper edge and lower edge of its side stile 161 of the window frame 16 so that the shutter 10 has a free end and can pivotally swing out of or in the window frame 16 with the fittings 20 functioning as a pivot.

The bearing body 21 of the fitting 20 is composed of a stationary plate 211, a movable plate 212 and a pin 213 pivotally engaging the stationary plate 211 with the movable plate 212. The stationary plate 211 is fixed immovably onto the upper and lower portion in either one of two stiles 161 of the window frame 16, and the movable plate 212 is fixed onto the predetermined upper edge and lower edge of the shutter 10.

The support plate 22 made integral to extend traversely from lower edge of the movable plate 212 into a predetermined length, provided with plural screw holes 221 for mounting screws to pass through and further fasten the support plate 22 either on the top block 13 or the bottom block 14 thereon.

The reinforcing rib 23 taking the shape of triangular form extending and made integrally therefrom the center of abutting portions of the movable plate 212 and support plate 22 oriented towards the respective surface of the shutter 10, such two sides of the reinforcing rib 23 are vertically positioned to one another and respectively connected to the support plate 22 and movable plate 212 thereon

The shutter 10 has one side block 11 provided with a sidewise rabbet groove 111 in corresponding position to the reinforcing rib 23 so as to allow the reinforcing rib 23 to be inserted therein.

However, it is necessary to mention that the position of the reinforcing rib 23 may be positioned either at the central section of the movable plate 212 and the support plate 22 facing towards the edge portion of the shutter 10 or exterior edge of the abutting portion of the movable plate 212 and the support plate 22, and its shape may be either in triangular, rectangular, L-shaped, wedge-shaped, with at least a projection or a combination of those describing shapes.

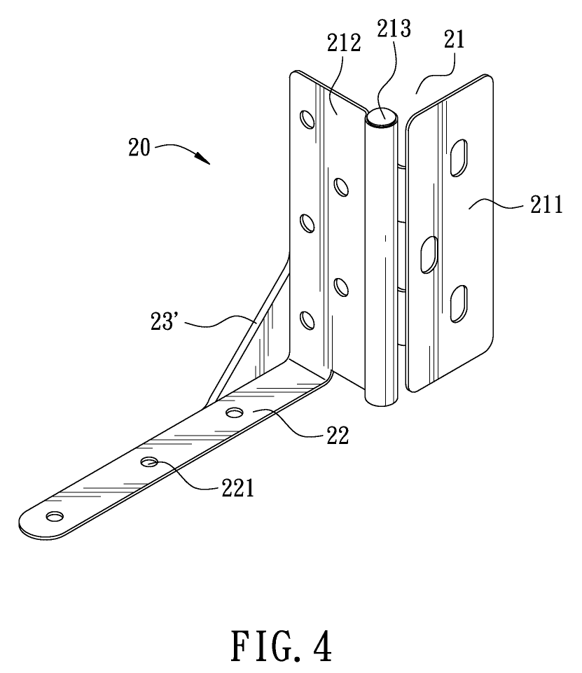

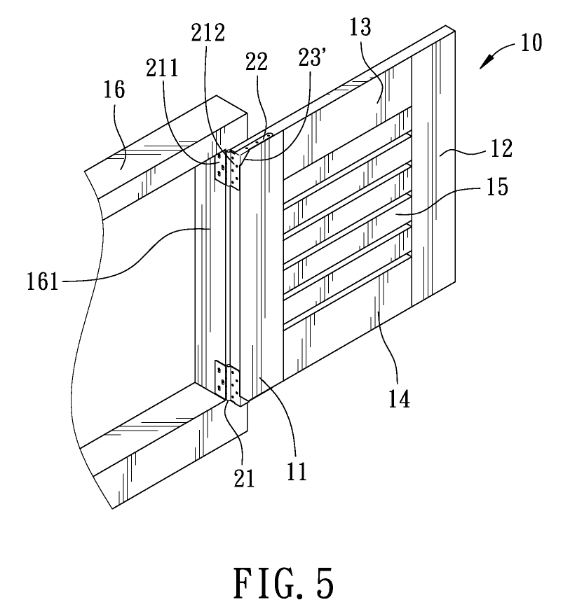

Next, FIGS. 4 and 5 show a second preferred embodiment of a fitting for a shutter in the invention, having almost the same structure of the first one, except that the reinforcing rib 23 in the first one is replaced by a reinforcing rib 23′, with two respective end s are fixingly connected onto the adjoining edges of the movable plate 212 and the support plate 22, so that the reinforcing rib 23′, support palte 22 and movably plate 212 are perpenticularly positioned to one another and further envelop one corner of the shutter 10 to reinforce the mechanical strength of the shutter 10 at the same time.

The invention has the advantages as follows, as can be understood by the foresaid description.

1. The reinforcing rib further improves the mechanical strength of the support plate and at the same time further supports the shutter weight, preventing the support plate from deforming gradually, improving the stability of the oscillating-swing shutter during operations.

2. It can effectively limit the scope of opening and closing of the shutter, so as to be only rotatable about a horizontal axis of the fitting.

3. The fitting is made integral, having a simple structure with sufficient mechanical strength but low in manufacturing costs.

While the preferred embodiments of the invention have been described above, it will be recognized and understood that various modifications may be made therein and the appended claims may cover all such modifications that may fall within the spirit and scope of the invention.

What is claimed is:

1. A fitting for mounting a shutter sash on a window frame, said fitting comprising:
a bearing body comprising of a stationary plate and a movable plate pivotally engaged together, said stationary plate is securely mounted onto said window frame, said movable plate is fixed on a portion of said shutter sash;
a support plate longitudinally extending therefrom an appropriate portion of said movable plate in a predetermined length and width; and
a reinforcing rib taking a form of a predetermined shape extending from corresponding surface of said support plate in an orientation towards a respective surface of said shutter sash.

2. The fitting according to claim 1, wherein two sides of said reinforcing rib are vertically positioned to one another, and respectively connected firmly with adjoining portions of said movable plate and said support plate.

3. The fitting according to claim 1, wherein said reinforcing rib takes a form of L-shaped positioning in a center of abutting portions of said movable plate and said support plate.

4. The fitting according to claim 1, wherein a predetermined portion of said reinforcing rib is respectively connected onto corresponding surfaces of said movable plate and said support plate facing towards an appropriate portions of said shutter sash.

5. The fitting according to claim 1, wherein said reinforcing rib is a triangular shaped plate.

6. The fitting according to claim 1, wherein said reinforcing rib is a rectangular shaped plate.

7. The fitting according to claim 1, wherein said reinforcing rib is a wedge-shaped plate.

8. The fitting according to claim 1, wherein said reinforcing rib is at least provided with a projection.

9. A fitting for mounting a shutter sash on a window frame, said fitting comprising:
a bearing body comprising of a stationary plate and a movable plate pivotally jointed together, said stationary plate is securely mounted onto said window frame, said movable plate is fixed at inner portion of said shutter sash;
a support plate longitudinally extending from an appropriate portion of said movable plate in a predetermined length;
a reinforcing rib taking a form of a predetermined shape extending therefrom a predetermined portion of said movable plate of which facing towards the corresponding surface of said shutter sash; and
said shutter sash having a rabbet groove positioned in a corresponding location to said reinforcing rib for said reinforcing rib to be fixingly inserted therein.

10. The fitting according to claim 9, wherein said reinforcing rib extends from said movable plate towards the corresponding surface of said shutter sash and further form a plate into a predetermined shape.

11. The fitting according to claim 9, wherein two sides of said reinforcing rib are vertically positioned to one another, and respectively connected firmly with adjoining portions of said movable plate and said support plate.

12. The fitting according to claim 9, wherein said reinforcing rib takes a form of L-shaped positioning in a center of abutting portions of said movable plate and said support plate.

13. The fitting according to claim 9, wherein a predetermined portion of said reinforcing rib is respectively connected onto corresponding surfaces of said movable plate and said support plate facing towards a portion of said shutter sash.

14. The fitting according to claim 9, wherein said reinforcing rib is a triangular shaped plate.

15. The fitting according to claim 9, wherein said reinforcing rib is a rectangular shaped plate.

16. The fitting according to claim 9, wherein said reinforcing rib is a wedge-shaped plate.
